(19) United States
(12) Patent Application Publication
(10) Pub. No.: US 2017/0278121 A1
(43) Pub. Date: Sep. 28, 2017

(54) PROTECTING DIGITAL SECURITY AND EFFECTIVENESS OF AN INCENTIVE

(71) Applicant: Treats, Inc., San Francisco, CA (US)

(72) Inventor: Lucas Andrew Duplan, San Francisco, CA (US)

(21) Appl. No.: 15/080,411

(22) Filed: Mar. 24, 2016

(51) Int. Cl. G06Q 30/02; H04L 9/08

(52) U.S. Cl. CPC G06Q 30/0209; H04L 9/088

(57) ABSTRACT

An incentive is to be securely provided. A security authentication identification is received. The security authentication identification is authenticated. Based at least in part on a random chance, a selected incentive value of the incentive to be awarded in the event an incentivized action is completed is selected. Access to at least a portion of an interactive computer game is allowed. An indication that the incentivized action has been completed is received. The indication that the incentivized action has been completed is validated. In the event the indication has been verified, the selected incentive value is awarded.

### BACKGROUND OF THE INVENTION

Incentives may be provided to incentivize a user to perform an action via a computer application (e.g., mobile device application). For example, digital credits may be provided to a user to encourage the user to download and install an updated version of the computer application. However, when any incentive of value is offered in a digital environment, there is a chance that hackers will illegitimately hack, abuse, or steal the incentive. Often the goal of the incentive is to incentivize the largest number of users to perform the incentivized action within a limited incentive budget and any security breaches that illegitimately take away from the incentive budget will reduce the performance of an incentive campaign. Therefore there exists a need for a secure way to offer, verify, and provide an incentive that will induce the largest number of users to perform the incentivized action for a given incentive budget.

### BRIEF DESCRIPTION OF THE DRAWINGS

Various embodiments of the invention are disclosed in the following detailed description and the accompanying drawings.

FIG. 1 is a block diagram illustrating an embodiment of a system for securely managing and providing an incentive.

FIG. 2 is a flowchart illustrating an embodiment of a process for configuring an incentive campaign.

FIG. 3 is a flowchart illustrating an embodiment of a process for providing an incentive.

FIG. 4 is a flowchart illustrating an embodiment of a process for verifying completion of an incentivized action.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Securely and effectively providing an incentive to a user is disclosed. For example, in order to encourage a certain behavior/action of a user of a computer application (e.g., application of a mobile, tablet, desktop, wearable, web, etc.), an incentive is provided interactively via the application. In some embodiments, a developer of an application has integrated into the application a software development kit (SDK) provided by a third party that will handle and manage an incentive campaign to encourage users to complete an incentivized action. For example, the application developer desires to increase user engagement of the application and has integrated the SDK that will implement within the application an incentive campaign to incentivize the increased user engagement. However, in order to prevent abuse and other security breaches, the tracking and awarding of incentives must be protected from hackers.

In some embodiments, an incentive campaign management server receives a security authentication identification. For example, a secret cryptographic key is received from an application implementing an incentive campaign and the secret cryptographic key is to be authenticated to verify that communication was sent from an authorized version of the application that is authorized to implement the incentive campaign. The security authentication identification is authenticated. A selected incentive value to be awarded based at least in part on a random/probabilistic chance is preselected. For example, the amount of value of the incentive that may be awarded if a user completed the incentivized action is variable and at least in part randomly preselected for the user. In one example, there exists an incentive prize pool of various incentive values and the user is to be awarded one randomly selected incentive value from the incentive prize pool. However, random selection of the prize value is based on a probability distribution of the various incentive values within the incentive prize pool. For example, the probabilities of being awarded the various different incentive values are adjusted such that the average expected incentive value is below a preset limit.

In some embodiments, a trigger condition is detected and access to at least a portion of an interactive computer game is provided. For example, when a triggering condition (e.g., application launched, specific application screen reached, etc.) is detected, a user is provided with an invitation to earn an incentive upon completion of a specified incentivized action. However, in order to encourage the user to engage with the invitation rather than merely dismiss the invitation, the user is provided with an opportunity to play an interactive computer game. For example, the interactive game may be an interactive graphic and/or a skill-based graphical video game. In some embodiments, a potential maximum incentive value that could be awarded for completing the incentivized action is indicated to a user and the interactive game provides one or more clues about the actual incentive value that will be awarded for completing the incentivized action. In some embodiments, although it may appear that the value of the award to be provided for completing the incentivized action is unknown prior to completing the incentivized action, the value of the award has been actually predetermined and the user is provided an alternative way (e.g., visit an alternative website, provide a physical mail request, etc.) to find out the value of the award prior to completing the incentivized action for the incentive.

When a completion indication is received that the incentivized action has been completed by a user, the completion indication is authenticated to ensure that the completion indication is valid and authorized. For example, the completion indication must be provided along with a security key and the security key must be verified as valid for a particular incentive in order to authenticate the completion indication. In some embodiments, upon receiving the completion indication, the user is provided an opportunity to complete a previously started interactive game. For example, when the interactive game was initially provided to the user, the interactive game was suspended in the middle of game play and the user was required to perform the incentivized action to resume the game. Upon completion of the game and/or upon the completion indication of the incentivized action, the selective incentive is awarded to the user.

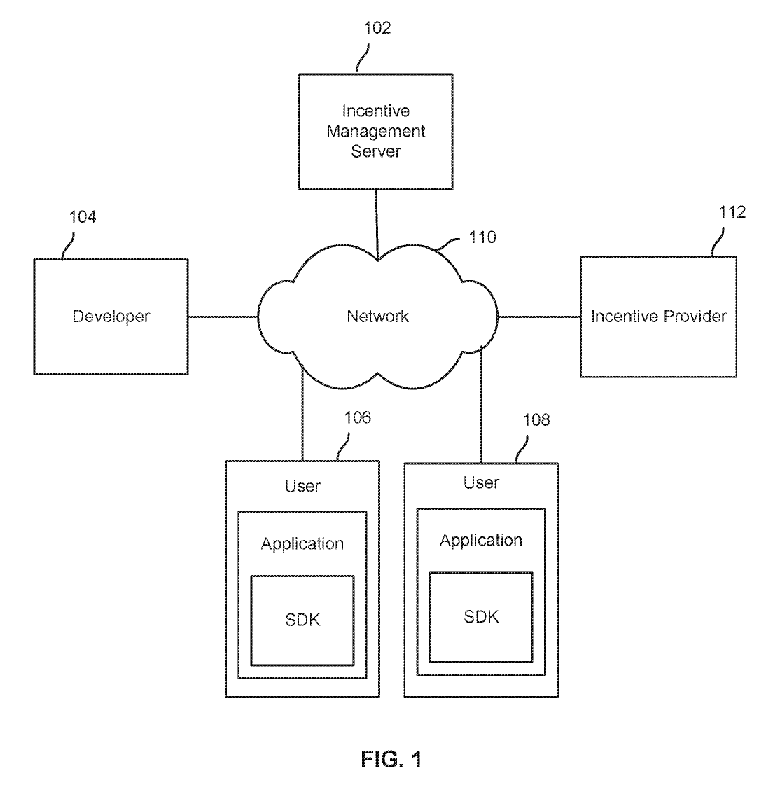

FIG. 1 is a block diagram illustrating an embodiment of a system for securely managing and providing an incentive. Incentive management server 102 is connected to developer system 104, incentive provider system 112, user system 106, and user system 108 via network 110.

In some embodiments, a developer utilizes developer system 104 to develop an application utilized by a user of user system 106. Examples of the application include a mobile/tablet/wearable device application, a desktop system application, a web application, a website, and any other computer program. However in order to encourage a user of the application to complete a specific action associated with the application (e.g., refer other users to also utilize the application), the developer/entity of the application would like to offer an incentive to any user that completes an incentivized action. However, correctly, securely, and effectively implementing and managing the incentive campaign to encourage the incentivized action takes a large amount of effort from the developer that detracts from the main focus of the application. Rather than independently developing code to implement the incentive campaign from scratch, the developer may integrate an SDK and/or application programming interfaces (API) (e.g., SDK provided by a third-party provider of incentive management services) into the application to allow a third party to implement and manage the incentive campaign. For example, the SDK integrated into the application has been provided by a third-party entity managing incentive management server 102. In some embodiments, the developer may interact with an interface to incentive management server 102 to offer, fund, enable, disable, track, and otherwise manage the incentive campaign.

User systems 106 and 108 are running the application developed using developer system 104. The integrated code of the SDK implementing the incentive campaign interfaces with incentive management server 102 via network 110 to offer, verify, track, and otherwise implement the incentive campaign on the application. For example, when a trigger action is detected on the application (e.g., application launched for the tenth time), an invitation to complete an incentivized action to earn an award is presented to a user via the application based at least in part on data obtained from management server 102. In some embodiments, rather than offer an incentive of a fixed value for every completion of an incentivized action, a user is provided an opportunity to win an incentive from incentives of variable values that is at least in part randomly/probabilistically selected for the user. For example, rather than earning ten points for completing an action, the user may either win five points or one hundred points for completing the action based on a random/probabilistic selection. However, the user will be provided an opportunity to find out the actual incentive value that has been predetermined prior to completing the incentivized action. In some embodiments, the opportunity of the incentive is presented to a user using an interactive computer game. For example, the user is provided via the application and the integrated code of the SDK, an opportunity to play an interactive game to reveal, select, and/or earn the value of the incentive that can be awarded for completing the incentivized action.

In the embodiment shown, once it is verified that a user has completed an incentivized action, the user is awarded the incentive. The completion of the incentivized action may be verified by incentive management server 102. Awarding the incentive may include providing the incentive via the application of the user (e.g., digital credit/content provided within the application) and/or via a third-party incentive provider system (e.g., incentive provider system 112) that fulfills the incentive payout (e.g., third-party merchant/bank fulfills the incentive).

Because there is a chance that hackers will illegitimately hack, abuse, or steal the incentive, the application of user system 106 or user system 108 must authenticate itself to management server 102 and management server 102 must be able to authenticate and security verify completion of an incentivized action that results in a payout of the incentive.

Examples of user devices 106 and 108 include a laptop computer, a smartphone, a tablet computer, a desktop computer, a wearable device, a smartwatch, and any other electronic computing device of a user. Examples of developer system 104, management server 102, and incentive provider system 112 include one or more of any of the following: a desktop computer, a server computer, a laptop computer, a cloud computing platform/server, a cluster, and any other network connected computer system. One or more of the following may be included in network 110: a direct or indirect physical communication connection, mobile communication network, Internet, intranet, Local Area Network, Wide Area Network, Storage Area Network, a wireless network, a cellular network, and any other form of connecting two or more systems, components, or storage devices together. Additional instances of any of the components shown in FIG. 1 may exist. For example, multiple hubs may be deployed and utilized in a single environment. Multiple developer systems and user systems may utilize and interface with a cluster of incentive management systems. The example of FIG. 1 has been simplified to illustrate the embodiment clearly and components not shown in FIG. 1 may also exist to provide functionality described in the specification.

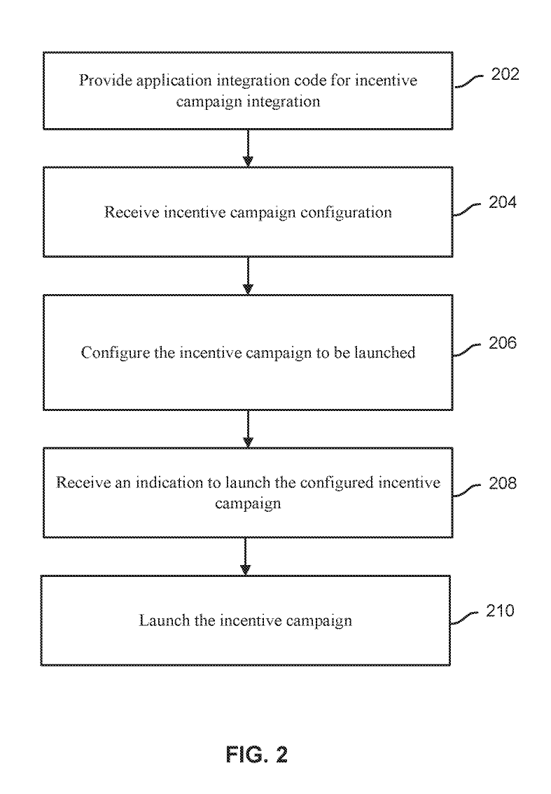

FIG. 2 is a flowchart illustrating an embodiment of a process for configuring an incentive campaign. The process of FIG. 2 may be at least in part implemented on incentive management server 102 of FIG. 1.

At 202, application integration code for incentive campaign integration is provided. For example, in order to encourage a user of an application to complete a certain action associated with the application (e.g., encourage a user to subscribe to a feature of the application, refer a new user, etc.), a developer of the application might desire to offer an incentive to an application user that completes an incentivized action. However, correctly, securely, and effectively implementing and managing the incentive campaign to encourage the incentivized action takes a large amount of effort from the developer that detracts from the main focus of the application. Rather than developing code to implement the incentive campaign from scratch, the developer is provided, from a third-party, already developed application integration code to be integrated into the application to offer the incentive to users via the integrated application. In some embodiments, the providing the application integration code includes providing an SDK and/or application programming interfaces (API) that are to be utilized by the application to integrate an incentive campaign into the application. In some embodiments, the developer integrates the provided application integration code into an application by invoking the application integration code at specific points in the code of the application to offer, redeem, and/or track an incentive.

At 204, incentive campaign configuration is received. In some embodiments, in order to start a new incentive campaign to incentivize an incentivized action, configuration details of the new incentive campaign are received. For example, using an incentive campaign builder (e.g., provided via a web interface), a customer (e.g., developer/entity of the application) of an incentive campaign management service configures a new incentive campaign by providing details about the incentive campaign to be launched. In some embodiments, receiving the incentive campaign configuration includes receiving an identification of a type of incentive campaign to be launched, target cost per incentivized action, total budget of the campaign, type of incentive to be offered, and/or values of incentives to be offered.

In some embodiments, receiving the incentive campaign configuration includes receiving an identification of a type of incentive campaign to be launched. For example, there exists different types of incentive campaigns based on a type of action to be incentivized, a type of incentive to be offered, and/or any other aspect of an incentive campaign, and the developer may select an identifier of an incentive campaign type from a list of campaign types. Examples of types of actions to be incentivized include a referral action (e.g., incentive provided for referring a new user), a convert action (e.g., incentive provided for subscribing to a premium feature), a loyalty action (e.g., incentive provided for purchasing a set number/amount of products/services), a purchase action (e.g., incentive provided for purchasing a product/service), a completion action (e.g., incentive provided for completing a survey), etc. and there exists one or more types of different incentive campaigns for each of the types of actions to be incentivized. By selecting the type of incentive campaigns, the preset configurations associated with the selected incentive campaign types become associated with the specific campaign to be launched.

In some embodiments, receiving the incentive campaign configuration includes receiving an identification of a type of incentive to be offered. Examples of types of incentives that may be offered include monetary incentives, digital point incentives, digital credit incentives, digital goods incentives, product incentives, service incentives, discount incentives, and any other incentive of value to a user.

In some embodiments, receiving the incentive campaign configuration includes receiving an identification of a target cost per incentivized action and/or a total budget of the campaign. For example, the target cost per incentivized action (e.g., cost per action/acquisition (CPA)) identifies the total monetary value that an entity would like to spend on average per each incentivized action. In some embodiments, a third-party entity managing and/or implementing the incentive campaign charges a fee for its incentive campaign implementation/management services and the fee is charged per successfully completed incentivized action. For example, the target cost per incentivized action is inclusive of the fee per action and the average incentive value awarded per successfully completed incentivized action is the target cost per incentivized action minus the fee. The total budget of the incentive campaign specifies the total overall budget for all awarded incentives for the campaign (e.g., award values plus fees).

By knowing target cost per incentivized action, fees, and/or the total budget, a distribution of incentives to be awarded may be determined. For example, rather than simply awarding the same incentive value for each successful completion of the incentivized action, a user is to be provided an opportunity to be awarded a randomly selected award from a range of different incentive value awards. The distribution of incentive values of these awards may be automatically determined based on the target cost per incentivized action, fees, and/or the total budget for a particular incentive campaign type to maximize the number of incentivized actions completed. For example, certain types of incentive campaigns may perform better with rare but large value incentives while other types of incentive campaigns may perform better with higher value minimum guaranteed awards.

In some embodiments, the distribution of incentive values (e.g., value amounts and number of incentives to be awarded for each value) is based at least in part on a logarithmic scale. The distribution of incentive values may be at least in part determined using a historical analysis of performances of one or more similar previously completed campaigns. In some embodiments, determining the distribution of incentives includes determining a distribution that minimizes the amount of the cost per incentivized action for a target number incentivized actions to be successfully completed. In some embodiments, a developer is provided an opportunity to directly specify the distribution of incentive values and/or modify an automatically determined distribution.

At 206, the incentive campaign to be launched is configured. For example, the server handling the management and backend processing of the incentive campaign is configured based on the received configuration to handle the incentive campaign. In some embodiments, configuring the incentive campaign includes configuring the incentive awards. For example, the distribution of incentives available to be awarded is finalized and probabilities associated with each incentive award value is determined. These probabilities may be utilized to randomly/probabilistically select (e.g., based on the probability distributions) the incentive value that will be awarded after completion of the incentivized action. In some embodiments, configuring the incentive campaign includes configuring security settings. For example, one or more secret and/or encryption keys are generated/selected for the particular incentive campaign and the key(s) are exchanged between the application (e.g., application being developed on developer system 104) and the management server (e.g., server 102 of FIG. 1) to allow the application and the server to security authenticate and communicate with each other.

At 208, an indication to launch the configured incentive campaign is received. For example, although a developer has already integrated code to offer the incentive campaign via the application, the incentive campaign does not become active until the incentive campaign is launched. Using a configuration manager, the developer is able to launch, stop, modify, and/or pause the incentive campaign.

At 210, the incentive campaign is launched. For example, an incentive management server and/or application instances are configured to offer, accept, and provide the incentives to encourage completion of the incentivized action.

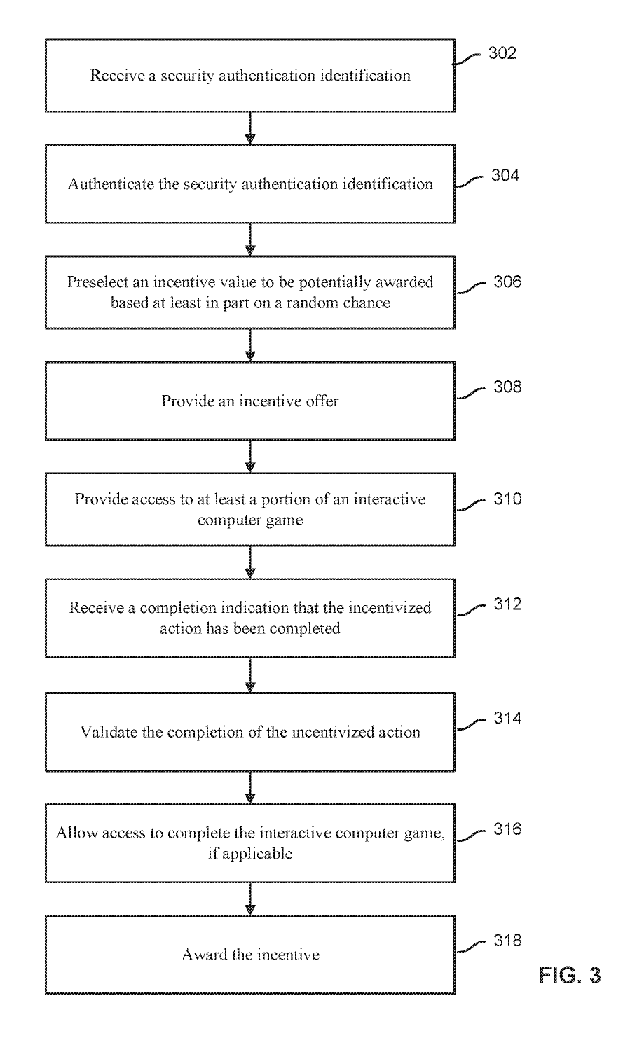

FIG. 3 is a flowchart illustrating an embodiment of a process for providing an incentive. The process of FIG. 3 may be at least in part implemented on incentive management server 102 of FIG. 1. In some embodiments, the process of FIG. 3 is included in 210 of FIG. 2.

At 302, a security authentication identification is received. In some embodiments, the security authentication identification is received from an application (e.g., application of user system 106 of FIG. 1) being launched. For example, when an application that includes code to implement an incentive campaign (e.g., programmed using SDK provided in 202 of FIG. 2) first launches, the application is established via a network connection with a remote incentive management server and the security authentication identification is provided to authenticate the application with the management server. In some embodiments, security authentication identification is provided via a secure network connection. For example, the application establishes a connection using Transport Layer Security (TLS), Secure Sockets Layer (SSL), or other cryptographic protocol (e.g., using public key cryptography) to establish a secure connection to a trusted incentive management server. The security authentication identification may be a secret key. For example, the security authentication identification is a secret key that has been pre-exchanged with an incentive management server (e.g., exchanged with server 102 of FIG. 1 at 208 of FIG. 2). The security authentication identification may be encrypted with a public key of the recipient to allow secure transfer of the security authentication identification and the recipient may access the security authentication identification by decrypting with a corresponding private key of the public key.

In some embodiments, identification of a specific user and/or application instance is provided along with the security authentication identification. For example, a user identifier, an email address, a username, a phone number, an application serial number, a user profile, an application identifier, or any other user or application specific information may be provided.

At 304, the security authentication identification is authenticated. For example, the security authentication identification is verified as a valid security authentication identification to trust the authenticity of the sender as a valid application implementing an identified incentive campaign. In some embodiments, authenticating the security authentication identification includes verifying that the security authentication identification matches an expected security authentication identification of an application of the sender. For example, a public key encrypted form of the security authentication identification is decrypted using a corresponding private key and the security authentication identification is compared with a stored version of the security authentication identification associated with the application, the user, and/or the incentive campaign. The stored version of the security authentication identification may be stored in a database/table/list that associates stored security authentication identifications and corresponding applications that are implementing incentive campaigns managed by an incentive management server. In some embodiments, an identifier of the user and/or application of the sender provided along with the security authentication identification is utilized to verify that the identified application and/or user is the actual identified user or application.

In some embodiments, the security authentication identification is unique to a particular application, user, and/or incentive campaign, and based on the received security authentication identification, an identity of the application, user, or incentive campaign is identified. Configuration and/or data corresponding to the identified user/application/campaign of the security authentication identification that has been authenticated may be retrieved from storage.

At 306, an incentive value to be potentially awarded is preselected based at least in part on a random (e.g., probabilistic) chance. For example, the value of the incentive that could be awarded for completing an incentivized action is variable based on chance, and the actual value of the award is predetermined before the user was provided the incentive award opportunity. In one example, the value of the incentive is preselected during startup processing each time the application implementing the incentive campaign is launched. In one example, the value of the incentive is preselected for each unique user. It may be important to predetermine the value of the award to avoid the incentive campaign from being mischaracterized as a gambling opportunity. By predetermining the value of the award, the element of chance in the incentive offer is removed prior to offering the incentive opportunity to a user.

In some embodiments, selecting the incentive value includes randomly selecting one of a plurality of candidate incentive values of an incentive campaign being implemented. For example, the candidate incentive values of the identified incentive campaign are identified (e.g., campaign identified using an identifier provided by the application implementing the incentive campaign) and one of these candidate incentive values is randomly/probabilistically selected based on a probability distribution corresponding to a preconfigured average incentive value (e.g., based on cost per action value specified in 204 of FIG. 2). In one example, in order to ensure that the average incentive value awarded for completing an incentivized action does not materially exceed the preconfigured average incentive value, a selection likelihood probability has been determined for each candidate incentive value to result a target average incentive value. In some embodiments, selecting the incentive value includes generating a random value and matching the random value to a particular probability distribution and selecting the corresponding incentive value. For example, a range of numbers is divided into subranges that each correspond to a different candidate incentive value (the size of each subrange corresponds to a selection probability of the corresponding candidate incentive value), a random value generated within the bounds of the range of numbers is matched to one of the subranges, and the incentive value corresponding to the matched subrange is selected. In some embodiments, preselecting the incentive value to be potentially awarded includes examining a history of incentive values that have been already awarded for the incentive campaign and adjusting the probability distribution of the candidate incentive values based on the history.

In some embodiments, one or more jackpot (e.g., large) candidate incentive values are not eligible to be selected until an award budget for the one or more jackpot candidate incentive values is available (e.g., award budget available such that awarding the jackpot candidate incentive value will not likely cause the target average incentive value to be exceeded). For example, one of the candidate incentive values that could be awarded is a large jackpot prize value and awarding the jackpot prize value before a significant number of incentivized actions has been completed could lead to a high-cost low-performance incentive campaign in the event a significant number of incentivized actions do not materialize later. The jackpot candidate incentive values may be identified by a developer or automatically identified when the incentive value is greater than a threshold value. In some embodiments, the award budget for the one or more jackpot candidate incentive values is based on one or more of the following: number of times a non-jackpot incentive value has been selected, a number of incentivized actions completed, a total value of all incentive values awarded for the incentive campaign, and a maximum incentive value that can be awarded without causing an average awarded incentive value to exceed a target average incentive value. In some embodiments, there exists a minimum incentive value and the selected incentive value cannot be less than the minimum incentive value.

In some embodiments, the selected incentive value is stored. For example, the selected incentive value is associated with a particular user and/or a particular application instance. In some embodiments, when a user requests to view the selected value, the user is provided the selected incentive value. For example, the user is required to submit a physical mail request to view the incentive value and/or electronically request to view the incentive value by submitting a unique identifier identifying the instance of the preselected incentive value. This unique identifier may be generated when the preselected incentive value was selected for the user and the unique identifier is provided to the user (e.g., via the user application implementing the incentive campaign).

At 308, an incentive offer is provided. For example, a user of an application implementing the incentive campaign is to be informed of an opportunity to earn an incentive for completing the incentivized action. A configuration of when, how, or what to offer may be provided to the application from a management server and the application provides the incentive offer based on the configuration. In some embodiments, the incentive offer is provided in response to a detected trigger condition. For example, the moment at which a user is provided the opportunity to earn the incentive may significantly affect whether the user will take the offer and the opportunity to earn the incentive is provided when certain triggers are detected. Specific points, screen location, user action, or content of the application implementing the incentive campaign may be indicated as trigger conditions that when detected cause a pop-up window informing the user about the incentive opportunity to be provided on the user application. For example, when a user launches a specific feature of the user application, an incentive offer for an incentivized action related to the specific feature is provided. Examples of the trigger include a posting of a transaction, a launch of an application, a request for a service, a purchase of an item, and a detection that a user is idle for a threshold amount of time. The triggers may be specified by a developer of the application and/or automatically determined based on properties of the incentive campaign.

In some embodiments, a limit of the rate at which the incentive offer is provided is predetermined and/or adjusted dynamically. For example, repeatedly prompting a user about the opportunity to earn the incentive for performing the incentivized action may annoy the user. In order to limit the rate at which the user is prompted, a limit may be placed on the maximum number of times the user may be prompted within a set period of time. For example, even though a trigger condition to prompt the user has been satisfied, if the number of times the user has been previously prompted with the incentive offer within the previous set amount of time has reached a threshold limit, the user is not prompted despite the trigger condition being met. The limit may be specified by a developer of the application (e.g., specified at 204 of FIG. 2) and/or automatically determined based on properties of the incentive campaign.

In some embodiments, when an invitation to provide the offer is provided, the exact value of the incentive that would be awarded upon completion of the incentivized action is not immediately apparent. For example, a range of the possible incentive values and/or the maximum incentive value that may be awarded is displayed to the user in the offer. However, the exact value of incentive that will be awarded upon completion of the incentivized action has been predetermined prior to the invitation and does not require any purchase or completion of the incentivized action from the user for the user to find out the exact incentive value that will be awarded upon completion. In some embodiments, the user is provided a content location link and/or an identifier (e.g., identifier dynamically generated to identify the incentive campaign/offer for the specific application instance/user) that the user can use to discover the exact incentive value that may be awarded. For example, the user may enter the provided identifier on a specified website to view the incentive value and/or the user may send a request via postal mail to request the exact incentive value. In some embodiments, the invitation is limited in time duration. For example, the user has a limited amount of time to indicate interest in the incentive offer and/or complete the incentivized action to be awarded the incentive.

At 310, access to at least a portion of an interactive computer game is provided. For example, when the user of the application implementing the incentive campaign is invited to complete an incentivized action to obtain an incentive, the user is provided an interactive game that simulates a chance-based and/or skill-based game. The user may play and interact with the interactive game. In some embodiments, there exists a plurality of different interactive computer games that could be provided and the exact interactive computer game to offer may be randomly/probabilistically selected and/or selected based on properties of the user and/or interactive campaign.

In some embodiments, the interactive computer game is automatically suspended in the middle of the game and cannot be completed until the user completes the incentivized action. This may provide a further motivation for the user to complete the incentivized action. For example, the user is provided three spinning wheels with various incentive values and the user may press each different button to stop each wheel at an incentive value. Although the user is allowed to stop two of the three wheels, the third wheel can only be stopped after completion of the incentivized action and the exact incentive value that will be awarded to the user is shown by where the third wheel stops. In various embodiments, a potential maximum incentive value that could be awarded for completing the incentivized action is indicated to a user via the game and the interactive game provides one or more clues about the actual incentive value that will be awarded for completing the incentivized action.

In some embodiments, the final incentive value that will be awarded to the user is based at least in part on a skill performance of the user on the interactive computer game. For example, at least a portion of the final incentive value awarded for completing the incentivized action is based on a skill-based score earned on the interactive computer game. In some embodiments, the final incentive value that will be awarded to the user is based on a performance of the user on the incentivized action. For example, the user is awarded a bonus (e.g., value multiplier bonus, fixed amount bonus, etc.) based on a number of completed incentivized actions (e.g., multiple referrals completed) and/or a value of the completed multiple incentivized actions (e.g., based on purchase amount).

In some embodiments, when the user accepts an invitation for the incentive offer, the user is directed to a screen that allows the user to at least in part complete the incentivized action. For example, the user is provided a location/screen within the application that allows the user to complete the incentivized action. In some embodiments, the incentivized action is to refer a new user/customer that signs up for an account/service or makes a purchase, and the user is prompted to provide contact information of the potential new users that the user would like to refer. Using the contact information, the potential new users may be contacted (e.g., via email, SMS, text message, instant message, social media message/posting, etc.) with the invitation of the referring user in a manner that tracks whether the referred user acts in response to the invitation.

At 312, a completion indication that the incentivized action has been completed is received. The completion indication may include an identifier of a user, the incentive campaign, an associated application, and/or the incentive value to be awarded. In some embodiments, the completion indication is received from a developer and/or management entity of the application implementing the incentive campaign. For example, the developer provides a list of identifiers of users that have successfully completed the incentivized action of the campaign. In some embodiments, the completion indication is received from the user to be rewarded the incentive for completing the incentivized action. For example, the user provides a notification that the user has completed the incentivized action and requests payment of the incentive. In some embodiments, the completion indication is received from a new referred user that the incentive recipient user has referred. In some embodiments, the completion indication is automatically determined. For example, progress of the incentivized action is automatically tracked and the incentive management server is automatically notified when the incentivized action has been completed. In some embodiments, the completion indication is provided using an authentication identification. For example, the authentication identification can be used to verify whether the completion indication has been provided by an authenticated source.

At 314, the completion of the incentivized action is validated. For example, before the incentive is awarded, the completion of the incentivized action is validated to ensure that the incentivized action has been actually completed by the appropriate user. In some embodiments, validating the completion includes authenticating a source of the received completion indication. For example, an authentication/secret key is provided along with the completion indication and the authentication/secret key is authenticated to verify that the key belongs to an entity/source authorized to provide the completion indication for a particular application and/or incentive campaign. The key may be the same key received in 302 of FIG. 3. In some embodiments, validating the completion includes independently verifying the completion of the incentivized action. For example, data from internal and/or external sources is utilized to automatically verify the completion. In some embodiments, the validating the completion includes validating that a dependent user has completed its share of the incentivized action. For example, the incentive is to be only awarded to a source user if another new user referred by the source user completes a specified action and it is verified whether the referred user has completed the incentivized action. The actions of the referred user may be tracked by requiring the referred user to utilize a specific identifier or content link that identifies the referral of the source user.

At 316, access to complete the interactive computer game is allowed, if applicable. For example, the interactive game allowed in 310 was suspended pending completion of the incentivized action and because the incentivized action has been completed, completion of the interactive game is allowed. In some embodiments, completing the interactive game includes revealing the exact value of the incentive to be awarded via the interactive computer game. For example, the user is provided a visual graphic of the incentive value when the user completes an interaction action of the interactive game. In some embodiments, the final incentive value to be awarded to the user is based at least in part on a skill performance of the user on the interactive computer game. For example, at least a portion of the final incentive value awarded for completing the incentivized action is based on a skill-based score earned at the completion of the interactive computer game. In some embodiments, the final incentive value to be awarded to the user is based on a performance of the user on the incentivized action. For example, the user is awarded a bonus (e.g., multiplier bonus, fixed amount bonus, etc.) based on a number of completed multiple incentivized actions (e.g., multiple referrals completed) and/or a value of the completed multiple incentivized actions (e.g., based on purchase amount).

In some embodiments, allowing the access to complete the interactive computer game includes providing a message to the user to be awarded. For example, an email message, a notification, an instant message, an in-application message, etc. is provided to the user that completion of the incentivized action has been verified and/or completion of the interactive computer game has been allowed. In some embodiments, allowing the access to complete the interactive computer game includes allowing access to complete the interactive game the next time the user launches the application implementing the incentive campaign. For example, when the user launches the application, the application checks with the incentive management server and the server indicates to the application to allow access to the interactive game and display the incentive to the user. The application then provides the interactive computer game to the user.

At 318, the incentive is awarded. In some embodiments, awarding the incentive includes providing an instruction to the application implementing the incentive campaign and/or to a backend server of the application to provide the incentive. For example, a digital good/service incentive award to be provided via the application is awarded by providing an instruction to the application and/or its backend server. The instruction may be encrypted/protected using an encryption/secret key and/or provided via an encrypted communication channel. In some embodiments, awarding the incentive includes providing an instruction to a third-party entity/server to provide the award. For example, in order to provide a monetary award, a payment processing service is provided an instruction to provide the monetary award to the user. In some embodiments, awarding the incentive includes performing accounting of the incentive campaign. For example, the value of the awarded incentive is deducted from an incentive campaign account and various accounting parameters of the incentive are updated (e.g., cost per action metric updated, amount available for jackpot prize updated, etc.). In some embodiments, awarding the incentive includes charging a management fee for successful completion of the incentivized action. For example, an entity providing the incentive campaign management charges a fee to the developer/customer utilizing the incentive campaign management/implementation services.

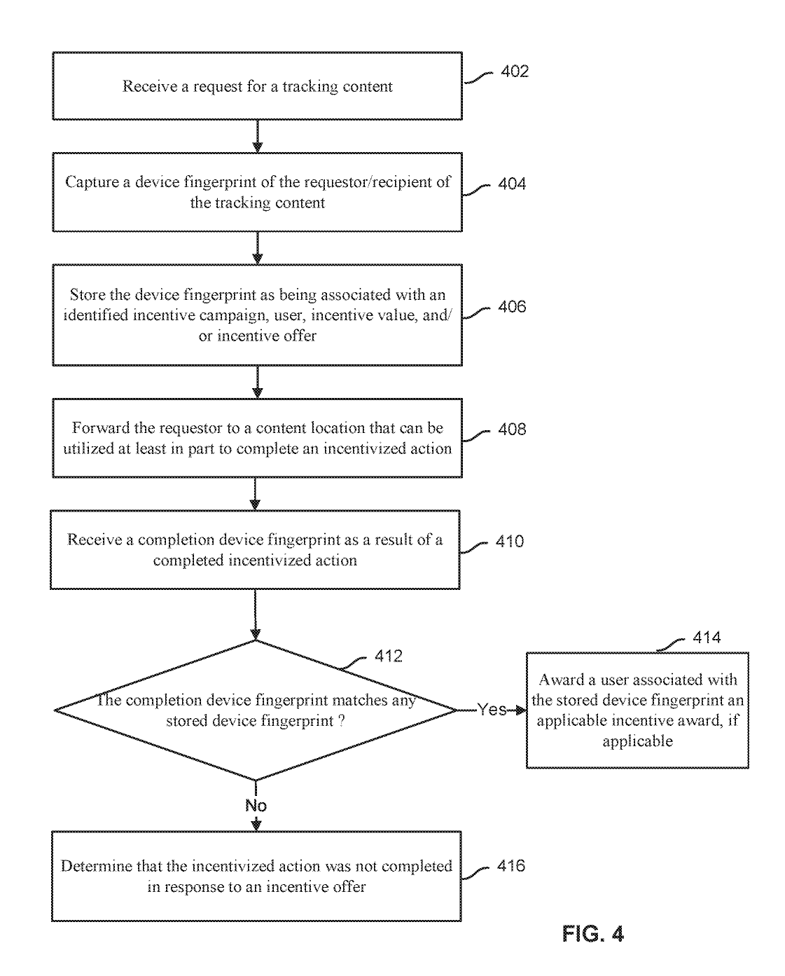

FIG. 4 is a flowchart illustrating an embodiment of a process for verifying completion of an incentivized action. The process of FIG. 4 may be at least in part implemented on incentive management server 102 of FIG. 1. In some embodiments, the process of FIG. 4 is at least in part included in 312 and/or 314 of FIG. 3.

At 402, a request for a tracking content is received. In some embodiments, the tracking content is requested when a user visits content, location, or a link of a web site or an application to complete an incentivized action. In some embodiments, the tracking content was linked in a message provided to a referred user that was referred by a source user to be awarded an incentive for an action completed by the referred user. For example, the source user is to be awarded the incentive if a referred user of the source user signs up for an account/service or makes a referred purchase. When contact information of the referred user was provided by the source user, the referred user was provided a link to the tracking content and the referred user visits the link to the tracking content to complete the referred user's share of the incentivized action. In some embodiments, receiving the request for the tracking content includes receiving a web content (e.g., webpage) request. In some embodiments, the request identifies a particular incentive campaign, user, incentive value, and/or incentive offer to allow tracking of an incentivized action completed in response to a specific incentive offer.

At 404, a device fingerprint of the requestor/recipient of the tracking content is captured. For example, the tracking content is web content and the web content captures the device characteristics of the requestor and associates the device characteristics with an associated incentive campaign, user, and/or incentive offer. The tracking content may capture the device fingerprint by providing a device property capture script to the requestor and the script returns the device fingerprint. In some embodiments, capturing the device fingerprint includes capturing properties of the requestor of the tracking content to generate a set of characteristics of the device that identifies the device that was utilized to request the tracking content. By knowing which device requested the tracking content, subsequent actions by the device can be correlated together to determine whether an action performed by the device was in response to an incentive offer. Examples of elements of the device fingerprint include one or more of the following: a display resolution height, a display resolution width, an operating system identifier, a web browser identifier, a MAC address, and an IP address.

At 406, the device fingerprint is stored as being associated with an identified incentive campaign, user, incentive value, and/or incentive offer. For example, an incentive identifier provided along with the request for the device fingerprint is associated with the device fingerprint and stored. The device fingerprint may be stored in a database/list along with other device fingerprints associated with other incentive campaigns, users, incentive values, and/or incentive offers.

At 408, the requestor is forwarded to a content location that can be utilized at least in part to complete an incentivized action. For example, the tracking content is provided as a visually blank webpage and once the tracking content has captured the device fingerprint of the requestor, the tracking content webpage automatically forwards/redirects the requestor to another webpage/content that can be utilized at least in part to complete the incentivized action. In some embodiments, the requestor is forwarded to content that can be utilized to download and/or install an application implementing the incentive campaign (e.g., forward referred user to download the application). In some embodiments, the requestor is forwarded to content (e.g., webpage, application screen, etc.) that can be utilized to provide requested information, complete a purchase, request a service, and perform any other action required to complete the incentivized action. In some embodiments, the requestor is forwarded to content (e.g., webpage, application screen, etc.) that indicates an incentive that a referral source user could be potentially awarded. For example, a range of the possible incentive values and/or the maximum incentive value that may be awarded to the referral source user for the referred user completing the incentivized action is displayed. In some embodiments, the requestor is forwarded to content (e.g., webpage, application screen, etc.) that indicates an incentive offer for the referred user for completing the incentivized action. For example, using at least a portion of the process of FIG. 3, the referred user is also to be provided an incentive in addition to or instead of the referral source user. The value of the incentive may also be preselected based on probabilistic chance and the referred user is provided an opportunity to play an interactive computer game to discover the referred user's preselected incentive value.

At 410, a completion device fingerprint is received as a result of a completed incentivized action. For example, when a referred user launches a newly installed application using new account credentials, the completion device fingerprint of the device launching the application is captured and provided to an incentive management server. The completion device fingerprint may have been also captured by a third-party when a user completes an incentivized action. For example, completion of the incentivized action is at least in part performed via a third-party and the third-party provides device fingerprints of devices that completed an action in completing the incentivized action. The received completion fingerprint may include one or more same type of elements as the device fingerprint captured in 404. For example, by utilizing the same element types, the completion device fingerprint may be compared with device fingerprints stored in 406.

At 412, it is determined whether the completion device fingerprint matches any stored device fingerprints. For example, the database/list of stored device fingerprints associated with incentive campaign referrals being tracked is searched to identify whether any of the stored device fingerprints matches the received completion device fingerprint. The database/list of stored device fingerprints may also identify devices associated with accepted incentive offers. By comparing and matching the device fingerprints, it may be determined whether the completed incentivized action was completed using a device identified as being associated with a particular incentive offer.

If at 412 it is determined that the completion device fingerprint matches a stored device fingerprint, at 414, a user associated with the stored device fingerprint is awarded an applicable incentive award, if applicable. For example, the stored device fingerprint is associated/linked to a particular incentive for a particular user and a particular randomly/probabilistically predetermined incentive value, and the particular user is awarded the predetermined incentive value for successful completion of the incentivized action. By using the device fingerprints to make a correlation between a device utilized to accept the incentive offer and the device that completed the incentivized action, it is determined that the incentivized action was completed in response/fulfillment of the incentive offer. In some embodiments, awarding the incentive award includes allowing access to the computer game in 316 of FIG. 3.

If at 412 it is determined that the completion device fingerprint does not match a stored device fingerprint, at 416, it is determined that the incentivized action was not completed in response to an incentive offer. In some embodiments, although it cannot be automatically determined that the incentivized action was completed in response/fulfillment of the incentive offer, a user is prompted for a referral code or any other identifier that can link the completion of the incentivized action to a particular incentive offer. If the code/identifier is verified, a user associated with the code/identifier is awarded an incentive award, if applicable.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for securely providing an incentive, comprising:
a communication interface configured to receive a security authentication identification; and
a processor coupled with the communication interface and configured to:
authenticate the security authentication identification;
based at least in part on a random chance, select a selected incentive value of the incentive to be awarded in the event an incentivized action is completed;
allow access to at least a portion of an interactive computer game;
receive an indication that the incentivized action has been completed;
validate the indication that the incentivized action has been completed; and
in the event the indication has been verified, award the selected incentive value.

2. The system of claim 1, wherein the security authentication identification is received from an application integrating an SDK implementing an incentive campaign.

3. The system of claim 2, wherein the SDK was provided by a third-party entity managing the incentive campaign.

4. The system of claim 1, wherein the security authentication identification includes a secret key and an identifier of an application or an incentive campaign.

5. The system of claim 1, wherein the security authentication identification includes a cryptographic key.

6. The system of claim 1, wherein authenticating the security authentication identification includes verifying that the security authentication identification matches an expected security authentication identification for an application that provided the security authentication identification.

7. The system of claim 1, wherein selecting the selected incentive value includes preselecting for a particular user the selected incentive value among a plurality of candidate incentive values prior to offering to the particular user an opportunity to be rewarded for completing the incentivized action.

8. The system of claim 1, wherein selecting the selected incentive value includes selecting the selected incentive value based on a predetermined probability distribution associated with a target average incentive value.

9. The system of claim 8, wherein the predetermined probability distribution has been automatically determined based at least in part on a specified average cost per incentivized action.

10. The system of claim 1, wherein the processor is further configured to detect that a trigger condition has been detected and in response providing an offer for the incentive and allowing access to at least the portion of the interactive computer game.

11. The system of claim 10, wherein the trigger condition is associated with a maximum rate limit on how often the incentive may be offered to a user.

12. The system of claim 1, wherein allowing access to at least the portion of the interactive computer game includes suspending the interactive computer game prior to a completion of the interactive computer game and allowing resumed access to the interactive computer game after is verifying that the incentivized action has been completed.

13. The system of claim 1, wherein the interactive computer game is skill-based and a total incentive awarded is based at least in part on a user performance on the interactive computer game.

14. The system of claim 1, wherein the interactive computer game provides one or more indications about a potential to be awarded the selected incentive value.

15. The system of claim 1, wherein the interactive computer game indicates a potential maximum incentive value that could be awarded for completing the incentivized action.

16. The system of claim 1, wherein a user is able to preview the selected incentive value for the user prior to completing the incentivized action.

17. The system of claim 1, wherein validating the indication that the incentivized action has been completed includes determining that a referred user referred by a user to be awarded the selected incentive value has completed at least a portion of the incentivized action.

18. The system of claim 1, wherein the indication that the incentivized action has been completed includes a device fingerprint and validating the indication includes matching the device fingerprint to a stored device fingerprint associated with a user to be awarded the selected incentive value.

19. A method for securely providing an incentive, comprising:
receiving a security authentication identification;
using a processor to authenticate the security authentication identification;
based at least in part on a random chance, selecting a selected incentive value of the incentive to be awarded in the event an incentivized action is completed;
allowing access to at least a portion of an interactive computer game;
receiving an indication that the incentivized action has been completed;
validating the indication that the incentivized action has been completed; and
in the event the indication has been verified, awarding the selected incentive value.

20. A computer program product for securely providing an incentive, the computer program is product being embodied in a tangible computer readable storage medium and comprising computer instructions for:
receiving a security authentication identification;
authenticating the security authentication identification;
based at least in part on a random chance, selecting a selected incentive value of the incentive to be awarded in the event an incentivized action is completed;
allowing access to at least a portion of an interactive computer game;
receiving an indication that the incentivized action has been completed;
validating the indication that the incentivized action has been completed; and
in the event the indication has been verified, awarding the selected incentive value.
